(19) United States
(12) Patent Application Publication
(10) Pub. No.: US 2025/0341895 A1
(43) Pub. Date: Nov. 6, 2025

(54) SIMULATION SUIT AND A SIMULATION APPARATUS OF A SIMULATION SYSTEM

(71) Applicant: Howard Yang, West Covina, CA (US)

(72) Inventor: Howard Yang, West Covina, CA (US)

(21) Appl. No.: 18/653,939

(22) Filed: May 2, 2024

(51) Int. Cl. G06F 3/01

(52) U.S. Cl. CPC G06F 3/016; G06F 3/011

(57) ABSTRACT

There is a simulation system including a simulation suit and a simulation apparatus. The simulation suit includes a plurality of adjustable pressure components, an electro muscular stimulation component, a magnetic field generation component, a temperature control component and a training helmet; all configured to stimulate pressure, temperature and force on a wearer. The simulation apparatus includes an operating component, a movement generating component, and a magnetic field generation component in coordination with the simulation suit to stimulate movement and magnetic directional forces experienced during various operating conditions of a simulation event. The simulation system also includes a haptic feedback system to provide tactile sensations to a wearer corresponding to various conditions.

### BACKGROUND OF THE INVENTION

### Field of the Invention

The present invention relates to simulation systems, specifically to a simulation suit and a simulation apparatus of a simulation system.

### Description of the Related Art

In the related art, simulated racing or racing simulation, commonly known as sim racing, are the collective terms for racing game software that attempts to accurately simulate auto racing, complete with real-world variables such as fuel usage, damage, tire wear and grip, and suspension settings. To be competitive in sim racing, a driver must understand all aspects of a race car that make real-world racing so difficult, such as threshold braking, how to maintain control of a car as the tires lose traction, and how properly to enter and exit a turn without sacrificing speed. It is this level of difficulty that distinguishes sim racing from arcade racing-style driving games where real-world variables are taken out of the equation and the principal objective is to create a sense of speed as opposed to a sense of realism.

Due to the complexity and demands of mimicking real-life driving, racing sims require faster computers to run effectively, as well as a steering wheel and pedals for the throttle and brakes for the immersion. While using a gamepad or even a mouse and keyboard, may suffice for most arcade-style driving games on home systems, it would not provide the same level of immersion and realism as using a racing wheel and pedals. In recent years, many sim racing experiences have been developed for consoles, such as the PlayStation and Xbox. While these games may be played with a controller, it is recommended that players invest in a racing wheel and pedals. With the development of online racing, the ability to drive against human opponents and computer AI offline is the closest many would come to driving cars on a real track. Even those who race in real-world competition use simulations for practice or for entertainment. With continued development of the physics engine software that forms the basis of these sims, as well as improved hardware (providing tactile feedback), the experience has become more realistic.

In the realm of virtual simulation, the quest to accurately replicate the physical sensations of G-force has always been a significant challenge. Existing G-force simulation technologies, while innovative in their own right, have limitations that prevent them from fully replicating the complex nature of G-forces experienced in real-world scenarios.

Current Technologies and their Limitations:

Mechanical Motion Platforms: These systems, commonly used in various simulation setups, rely on motors, hydraulics, or pneumatics to create movement. They may tilt, lift, drop, and shake the seat or platform, simulating basic motion and G-forces. However, they fall short in providing a nuanced sensation of G-forces, particularly in replicating the effects on different parts of the body. These platforms often require significant space and have limitations in motion range and fidelity. While effective for certain applications, they cannot fully emulate the complexity of real G-force sensations.

Centrifuge-Based Systems: Used primarily in astronaut training, these systems generate centrifugal force by rotating rapidly, simulating G-forces. These systems are effective but typically large and impractical for consumer use, limiting their application to specialized training environments.

Virtual Reality (VR) Systems: Offering immersive visual experiences, VR technology enhances the perception of movement and change in direction. However, the lack of corresponding physical feedback creates a disconnect, reducing the realism and effectiveness of the simulation.

### Bridging the GAP:

Safety Concerns and Accessibility: Real-world training for high-G environments in sectors like aerospace, motorsports, and the military involves significant risks and costs. The need for safer, more accessible simulation methods is increasingly important.

The Market Gap: Despite these advancements, there remains a distinct gap in the market for a comprehensive solution that may simulate G-force effects. Current technologies primarily address either the visual or basic motion aspects but do not fully encapsulate the physical sensations and muscle strains associated with varied G-force levels.

Invention Overview: The proposed G-force simulation suit aims to bridge this gap. By integrating pressure systems, electro muscular stimulation, and magnetic field technology, this suit offers a comprehensive, immersive, and safe simulation experience. This invention, a significant advancement in simulation technology, provides an integrated solution adaptable across various applications, from professional training to recreational virtual experiences. Unlike existing technologies, it offers a multi-dimensional approach, addressing the limitations of current motion platforms and VR systems, and providing a more authentic and versatile simulation experience.

Some improvements have been made in the field. Examples of references related to the present invention are described below in their own words, and the supporting teachings of each reference are incorporated by reference herein: U.S. Pat. No. 11,550,397 issued to Pezent et al, discloses a method that may include detecting motion of a user, estimating, for the detected motion of the user, effort expended by the user in performing the motion, determining, based on the detected motion and the estimation of expended effort, a haptic profile for conveying to the user a physical sensation of expending the effort, and simulating a sensation of expending the effort by executing the haptic profile in at least one haptic device that is worn by the user. Various other methods, systems, and/or computer-readable media are also disclosed.

U.S. Pat. No. 11,221,493, issued to Baker, discloses a virtual reality body suit assembly for participating in virtual reality includes a body suit and a plurality of body motion sensors integrated into the body suit to sense motion of respective parts of the person's body when the person wears the body suit. A personal electronic device is removably attachable to the body suit and the personal electronic device is in communication with each of the body motion sensors. Additionally, the personal electronic device is in wireless communication with a remote data server thereby facilitating the personal electronic device to communicate motion data received from the body motion sensors to a virtual reality program on the remote data server. In this way the personal electronic device facilitates the person to participate in the virtual reality program.

U.S. Pat. No. 11,199,903, issued to Jung et al., discloses systems and methods for providing enhanced surface electrical neurostimulation and haptic feedback to a user within a simulation environment are provided. Enhanced surface electrical neurostimulation (eSENS) platforms are able to elicit distally referred tactile percepts while avoiding large charge densities as a method to deliver intuitive haptic feedback during functional tasks.

U.S. Patent Application Publication No.: 2011/0067157, by Xiao, discloses variable low/zero gravity simulation systems. variable low/zero gravity condition is achieved by substantial immersion in a fluid environment (“buoyancy means”) and using power assist means/robotic displacement devices such as exoskeleton to help user's movement/gravity compensation and/or relief or change loads on the subject's torso and limbs that caused by the weight and shape of the “Buoyancy means”, so that user can experience the effect of the (variable) gravity environment being simulated, such as Zero gravity in which situation user could move effortlessly in a weightless environment. When combine with VR related technology, this can create vivid immersive simulations for extraterrestrial scenes and can be widely used for entertainment, game, training, healing and etc.

U.S. Patent Application Publication No.: 2017/0193858, by Segall, discloses a device for simulating wounds and injuries received during a trauma event includes a training suit worn over a manikin. A reservoir containing simulated blood is located between the back of the manikin and the training suit. Located on the training suit are various wound simulators such as leg, abdominal, arm, face, and neck wound simulators. The wound simulators are connected to a pumping and control system located inside the manikin, which controls the system such that pulse rates and blood loss are realistically simulated. The pumping and control system is wirelessly connected to an external control device, which allows a trainer to monitor and control the functions of the trainer. The ability to simulate a cricothyroidotomy, and other medical procedures related to airway management, is also provided.

The inventions heretofore known suffer from a number of disadvantages which include being unrealistic, being difficult to use, being difficult to simulate, being difficult to stimulate, being limited in use, being limited in application, being limited in motion, being limited to various conditions, being limited in various environments, being limited in safety, being limited in feedback, being limited in function, and being limited in training capabilities.

What is needed is a simulation suit and a simulation apparatus of a simulation system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available simulation suit and systems. Accordingly, the present invention has been developed to provide a simulation suit and apparatus that

According to one embodiment of the invention, there may be a simulation system that may include a simulation suit. The simulation suit may include a plurality of adjustable pressure components to stimulate pressure on a wearer. The plurality of adjustable pressure components may include a bladder for a fluid or air to flow therethrough and apply stimulation to a wearer. The simulation suit may include an electro muscular stimulation component to replicate a plurality of muscle strain and fatigue patterns on a wearer. The electro muscular stimulation component may include an array of electrodes to deliver electrical impulses with various intensity and pattern to stimulate muscle strain and fatigue patterns to a wearer.

According to one embodiment of the invention, the simulation suit may include a magnetic field generation component to stimulate magnetic directional forces on a wearer. The magnetic field generation component may include a plurality of electromagnets integrated throughout the simulation suit to generate interactive magnetic fields with adjustable intensity and polarity to a wearer. The simulation suit may include a temperature control component to stimulate various temperatures on a wearer. The simulation suit may include a training helmet to stimulate centrifugal force on a wearer.

According to one embodiment of the invention, the simulation suit may include a processor for real-time analysis of suit data from the components of the suit to adjust the components of the suit to real-time conditions and movement of the simulation apparatus. The simulation suit may include a sensor to monitor physiological responses of the wearer and environmental parameters of the simulation suit; wherein the simulation suit includes a safety component to disable the various components of the simulation suit during various conditions.

According to one embodiment of the invention, the simulation system may include a simulation apparatus. The simulation apparatus may include an operating component to simulate and display a simulation event. The simulation apparatus may include a movement generating component to simulate various movements in coordination with the simulation suit and the operating component. The simulation apparatus may include a magnetic field generation component in coordination with the simulation suit to stimulate magnetic directional forces experienced during various operating conditions of a simulation event.

According to one embodiment of the invention, the simulation apparatus may include a processor for real time analysis of apparatus data in relation to the simulation suit. The simulation apparatus may include a control component to coordinate movement of the apparatus in relation to the simulation suit. The simulation apparatus may include a suit sensor to monitor physiological responses of the wearer. The simulation apparatus may include a communication component to coordinate movement and magnetic field generation upon the simulation apparatus; wherein the simulation apparatus includes a safety component to disable the various components of the simulation suit during various conditions. The simulation system may also include a haptic feedback system to provide tactile sensations to a wearer corresponding to various conditions.

According to one embodiment of the invention, the present invention introduces a groundbreaking G-force simulation suit, the first of its kind to seamlessly bridge the gap between virtual experiences and the realistic physical sensations of G-forces. This innovation, at the forefront of simulation technology, redefines immersive training and entertainment experiences. It represents the culmination of interdisciplinary research and development, integrating advanced materials, electromechanical systems, and sophisticated control algorithms. Central to this invention is the innovative integration of multiple technologies, each contributing significantly to the G-force simulation experience: According to one embodiment of the invention, the present invention includes an advanced pressure systems: utilizing air, water, or oil-based mediums, the suit may simulate varying degrees of force on different body parts, crucial for replicating the sensation of G-forces during high-speed turns, rapid acceleration, or deceleration.

According to one embodiment of the invention, the present invention includes an electro muscular stimulation system (EMS): targeting specific muscle groups, the EMS technology replicates muscular strain and fatigue under high G-force conditions, enhancing both the realism of the simulation and its value as a training tool for physical endurance and muscle conditioning.

According to one embodiment of the invention, the present invention includes a magnetic field interaction: a novel approach using electromagnets enables the simulation of push and pull sensations associated with rapid movements, synchronized with the pressure systems and EMS for a cohesive and responsive experience.

According to one embodiment of the invention, the present invention includes a simulation suit designed with a focus on user experience, featuring intuitive interfaces and customization options for pressure, EMS intensity, and magnetic field strength. This adaptability allows the simulation suit to cater to a broad spectrum of users, from novice to professional, enhancing training effectiveness for scenarios like racing or pilot training where it realistically simulates conditions such as the intense lateral G-forces during sharp turns. For entertainment, it brings an unprecedented level of immersion, enabling users in gaming or virtual reality to experience realistic physical sensations aligned with their virtual activities.

According to one embodiment of the invention, the present invention is versatile by design, the simulation suit is suitable for various applications including racing simulators, flight training, diving simulations, skydiving practice, underwater training, weightless simulation, astronaut training programs, any type of high pressure, movement simulations, and opening new possibilities for high-fidelity training and entertainment experiences.

According to one embodiment of the invention, the present invention includes safety mechanisms. Safety is integral to the design, with intelligent sensors and control mechanisms constantly adjusting the simulation parameters to ensure user safety and maintain an immersive experience. This ability to simulate G-forces without the associated risks of physical high-speed environments or high-altitude conditions marks a significant advancement in simulation technology. The simulation suit also monitors physiological conditions of a wearer, wherein when physiological thresholds are met the simulation suit automatically shuts down the simulation suit and the simulation apparatus. The simulation apparatus also includes a safety mechanism to also shut off the simulation suit and the simulation apparatus if certain safety physiological conditions are met.

According to one embodiment of the invention, this invention represents a transformative step in simulation technology, prioritizing user experience to deliver a comprehensive, safe, and highly realistic G-force experience. By providing a multi-dimensional simulation that engages the user's body and muscles in ways previously unachievable, this simulation suit sets a new standard in immersive and interactive experiences, advancing the field of simulation technology with a keen focus on user engagement and future potential. Looking ahead, this invention is poised to open new avenues in how we train, entertain, and prepare for extreme environments, revolutionizing user interaction with simulation technologies.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a component diagram of a simulation suit, according to one embodiment of the invention;

FIG. 2 is a component diagram of a simulation apparatus, according to one embodiment of the invention;

FIG. 3 is a system diagram of a simulation system, according to one embodiment of the invention;

FIG. 4 is a front elevational view of a simulation suit, according to one embodiment of the invention;

FIG. 5 is a partial cross sectional view of a simulation suit and a wearer, according to one embodiment of the invention;

FIG. 6 is a perspective view of a simulation system, according to one embodiment of the invention; and

FIG. 7 is a perspective cut away view of a training helmet of a simulation suit, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

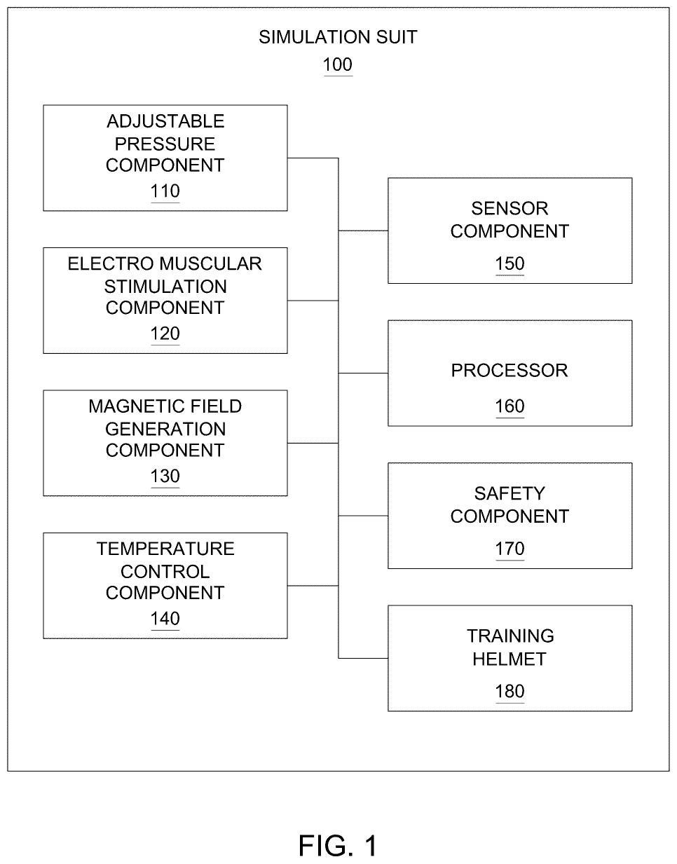

FIG. 1 is a component diagram of a simulation suit, according to one embodiment of the invention. There is shown a simulation suit 100 including an adjustable pressure component 110, an electro muscular stimulation component 120, a magnetic field generation component 130, a temperature control component 140, a sensor component 150, a processor 160, a safety component 170 and a training helmet 180.

According to one embodiment of the invention, there is a simulation suit 100. The simulation suit 100 may be, but not limited to, a racing suit configured to provide training components and capabilities to a wearer, such as the stresses and strains on a driver during a real life race car race/event. The simulation suit 100 is used in coordination with a simulation apparatus, such as a race car simulator. The race car simulator may be a race car simulator manufactured by GTR Simulator, 1004 Brooks St. Ontario, CA 91762. The simulation suit 100 includes an adjustable pressure component 110 to stimulate pressure on a wearer. The simulation suit 100 may include a plurality of adjustable pressure components 110 disposed throughout the simulation suit 100. The adjustable pressure component 110 includes a bladder for a fluid or air to flow therethrough and apply stimulation to a wearer. The adjustable pressure component 110 is designed to be displaced throughout the simulation sui 100, specifically to replicate the pressure and G forces applied on a wearer during real life race car driving. The adjustable pressure component 110 applies stresses and strains to muscle groups of a wearer to simulate the activity of real life race car driving. The adjustable pressure component 110 is in communication with a processor 160; wherein the processor 160 relays instructions to the adjustable pressure component 110 to apply stresses and strains to muscle groups for training purposes.

According to one embodiment of the invention, there is a simulation suit 100 including an electro muscular stimulation component 120. The electro muscular stimulation component 120 is designed to replicate a plurality of muscle strain and fatigue patterns on a wearer through electro-magnetic current that replicate the stresses and strains on a wearer during a real life race car event/race. The electro muscular stimulation component 120 is in communication with a storage device and a processor 160; wherein the processor 160 relays instructions to the electro muscular stimulation component 120 to replicate different muscle strain and muscle fatigue patterns through electric pulses throughout the simulation suit 100 that would replicate muscle strain and muscle fatigue patterns of real life race car racing. The electro muscular stimulation component 120 includes an array of electrodes to deliver electrical impulses with various intensity and pattern throughout the simulation suit 100 to train muscle groups to the stresses and strain of race car driving in various conditions. The array of electrodes are displaced throughout the simulation suit 100, specifically around muscles and limbs to replicate strain and fatigue on a wearer to simulate race car driving conditions.

According to one embodiment of the invention, there is a simulation suit 100 including a magnetic field generation component 130 designed to stimulate magnetic directional forces on a wearer to replicate stresses and strains of a real life race car event/race. The magnetic field generation component 130 includes a plurality of electromagnets integrated throughout the simulation suit 100 to generate interactive magnetic fields with adjustable intensity and polarity to a wearer. The magnetic field generation component 130 is designed to stimulate muscle strain and fatigue to simulate real life race car driving. The simulation suit 100 also includes a temperature control component 140 to adjust the internal temperature of the simulation suit 100. During a race car event/race, the driver must withstand high temperatures and loss of fluids during pro longed driving of a race car, the temperature component 140 allows a wearer to train for such conditions. The temperature control component 140 is designed to increase or decrease temperature of the simulation suit 100 based on various conditions of a race car driving simulation.

According to one embodiment of the invention, there is a simulation suit 100 including a training helmet 180 to stimulate centrifugal force on a head/neck of a wearer. The training helmet 180 includes a plurality of weights, set on a plurality of tracks to move about the training helmet 180 to simulate centrifugal force on a head/neck area of a wearer. The training helmet 180 is designed to simulate real life race car driving conditions and centrifugal force for real life virtual training or driving a race car.

According to one embodiment of the invention, the simulation suit 100 includes a processor 160 for real-time analysis of the components of the simulation suit 100. The processor 160 gathers data from the components of the simulation suit 100 to adjust the components of the simulation suit 100 to real-time conditions and movement of a simulation apparatus. The simulation suit 100 also includes a sensor component 150 to monitor physiological levels and responses of the wearer and environmental parameters of the simulation suit 100. The simulation suit 100 includes a safety component 170 in communication with the sensor component 150 to disable the various components of the simulation suit during various conditions. The safety component 170 is designed to shut off the components of the simulation suit 100 when a hazardous physiological limit has been reached.

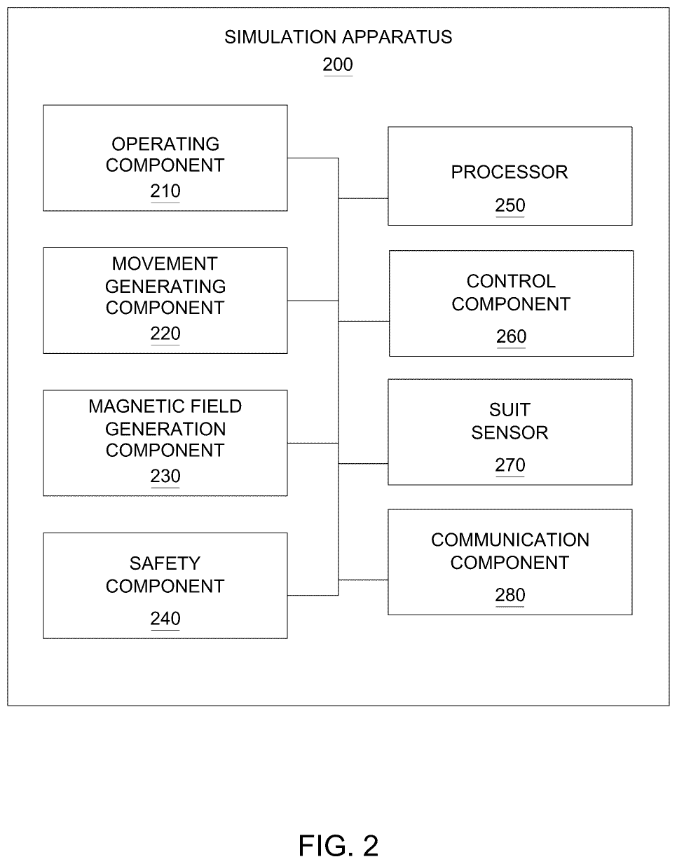

FIG. 2 is a component diagram of a simulation apparatus, according to one embodiment of the invention. There is shown a simulation apparatus 200 having an operating component 210, a movement generating component 220, a magnetic field generation component 230, a safety component 240, a processor 250, a control component 260, a suit sensor 270, and a communication component 280.

According to one embodiment of the invention, there is a simulation apparatus 200 of a simulation system. The simulation apparatus 200 may be, but not limited to, a race car simulator. The race car simulator may be a race car simulator manufactured by GTR Simulator, 1004 Brooks St. Ontario, CA 91762. The simulation apparatus 200 is designed to be a race car simulation device; the simulation apparatus 200 includes an operating component 210 to simulate and display a simulation event, such as, but not limited to a race car event/race. The simulation event may be race car event/race at a race track or race car venue. The operating component 210 is designed to display a point of view race car racing view within a frame or cockpit of a race car. The operating component 210 may include a steering wheel to operate a virtual race car or the like. The simulation apparatus 200 includes a movement generating component 220 to simulate various movements of a race car on a race track, in coordination with a simulation suit and the operating component 210. The movement generating component 220 may include a plurality of pistons or actuators to move a frame of the simulation apparatus to simulate movement of a race car on a race track.

According to one embodiment of the invention, there is a simulation apparatus 200 including a magnetic field generation component 230 in coordination with a simulation suit to stimulate magnetic directional forces experienced during various operating conditions of a simulation event; such as racing a race car at a race track. The simulation apparatus 200 includes a processor 250 for real time analysis of the components of the simulation apparatus 200. The processor 250 gathers data from the components of the simulation apparatus 200 in relation to a simulation suit. The processor 250 is designed to provide instructions to the simulation apparatus to provide a simulation event/environment. The simulation apparatus 200 includes a control component 260 to coordinate movement of the simulation apparatus 200 in relation to a simulation suit. The control component 260 in communication with the processor 250 stores instructions and simulations to display on the operating component 210 and for coordinating movement with the movement generating component 220.

According to one embodiment of the invention, there is a simulation apparatus 200 including a suit sensor 270 to monitor physiological levels and responses of a wearer of a simulation suit. The suit sensor 270 is in coordination with a sensor component of the simulation suit, to monitor the physiological levels and patterns of a wearer. The suit sensor 270 is also in communication with the components of the simulation suit to track data and patterns of the wearer. The simulation apparatus 200 also includes a communication component 280 to transmit and coordinate movement with the various components of the simulation apparatus with the various components of a simulation suit. The simulation apparatus 200 includes a safety component 240 to disable the various components of a simulation suit and the simulation apparatus 200 during various hazardous/dangerous operating conditions. The safety component 240 is designed to shut off the operating component 210, the movement generation component 220, and the magnetic field generation component 220 of the simulation apparatus 200; and the adjustable pressure component, the electro muscular stimulation component, and the temperature control component of a simulation suit.

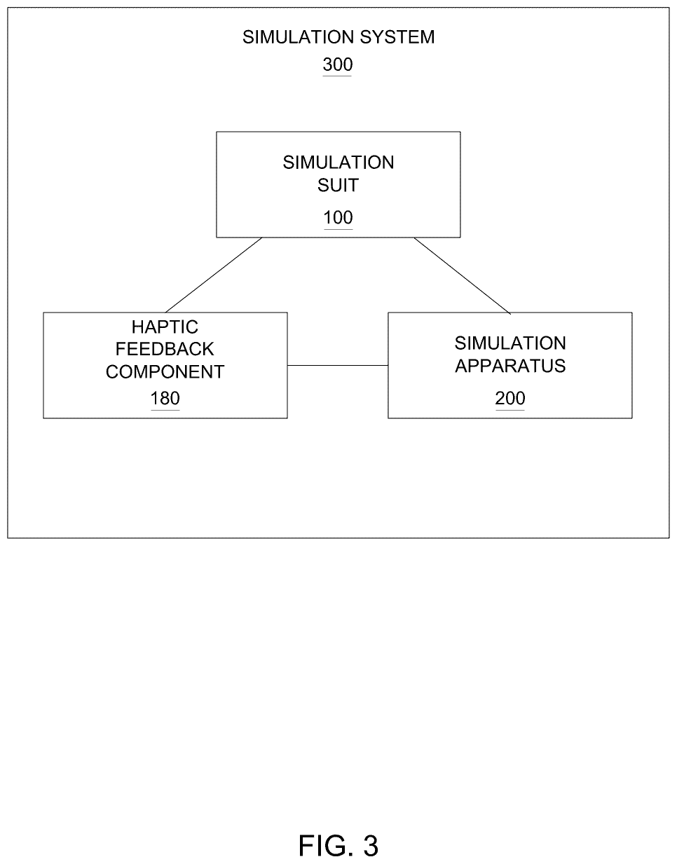

FIG. 3 is a system diagram of a simulation system, according to one embodiment of the invention. There is shown a simulation system 300 having a simulation suit 100 in communication with a simulation apparatus 200 and a haptic feedback component 180.

According to one embodiment of the invention, there is a simulation system 300 having a simulation suit 100 in communication with a simulation apparatus 200 and a haptic feedback component 180. The simulation suit 100 is in communication with the simulation apparatus 200 and designed to provide a simulation event; such as, but not limited to a race car simulator and a race car event/race. The simulation suit 100 includes features, functions and benefits for race car driving training in coordination with the simulation apparatus 200 to provide a real world race car simulation. The simulation suit 100 in coordination with the simulation apparatus 200 trains a wearer on the rigors, strains and stresses of racing a real life race car. The simulation suit 100 provides pneumatic pressure and electro muscular stimulation throughout the simulation suit 100 to replicate stresses and strains on muscle groups of a wearer, that the wearer would experience during a race car event/race. The simulation suit 100 also regulates the temperature of the suit, to simulate real life race car driving temperatures and conditions. The simulation suit 100 includes a training helmet designed to train a head/neck area of a wearer. The simulation suit 100 is designed to provide a complete training tool to simulate a real life race car race/event. The simulation suit 100 processes data from the various components of the simulation suit 100 to track physiological conditions of a wearer.

According to one embodiment of the invention, there is a simulation apparatus 200 in communication with the simulation suit 100. The simulation apparatus 200 includes an operating component to simulate and display a simulation event. The operating component of the simulation apparatus 200 includes a control device, such as a steering wheel; the operating component includes a display device, such as a multi-view screen display. The operating component includes a frame to support the various components of the simulation apparatus. The simulation apparatus includes a movement generating component, which may include hydraulic pistons or lifts to simulate movement of the frame experienced in a real life race car race or event The simulation apparatus may include a movement generating component to simulate various movements in coordination with the simulation suit and the operating component. The simulation apparatus includes a magnetic field generation component in coordination with the simulation suit to stimulate magnetic directional forces experienced during various operating conditions of a simulation event.

According to one embodiment of the invention, the simulation apparatus 200 includes a processor for real time analysis of apparatus data in relation to the simulation suit. The simulation apparatus includes a control component to coordinate movement of the apparatus in relation to the simulation suit. The simulation apparatus includes a suit sensor to monitor physiological responses of the wearer. The simulation apparatus includes a communication component to coordinate movement and magnetic field generation upon the simulation apparatus; wherein the simulation apparatus includes a safety component to disable the various components of the simulation suit during various conditions.

According to one embodiment of the invention, the simulation apparatus 200 also tracks data from the various components of the simulation apparatus to track race car parts, such as brake wear, tire wear, fuel consumption, etc. The simulation system 300 includes a haptic feedback component 180 to provide tactile feedback to a wearer of the simulation suit 100 based on various simulation suit and simulation apparatus conditions/environments.

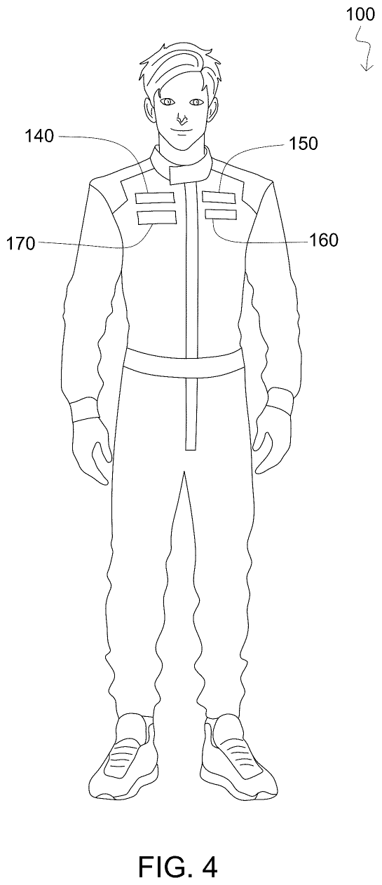

FIG. 4 is front elevational view of a simulation suit, according to one embodiment of the invention. There is shown a simulation suit 100 including a temperature control component 140, a sensor component 150, a processor 160, and a safety component 170.

According to one embodiment of the invention, there is a simulation suit 100 of a simulation system. The simulation suit 100 includes a plurality of adjustable pressure components, a plurality of electro muscular stimulation components, a plurality of magnetic field generation components disposed and interwoven throughout the simulation suit 100. The illustrated simulation suit 100 includes a temperature control component 140 designed to control the internal temperature of the simulation suit 100. The temperature component 140 is designed to simulate the temperature changes of a race car race/event.

According to one embodiment of the invention, the illustrated simulation suit 100 includes a sensor component 150 to monitor physiological responses of the wearer and environmental parameters of the simulation suit. The sensor component 150 is in communication with the various components of the simulation suit 100 to monitor physiological levels and patterns of a wearer.

According to one embodiment of the invention, the illustrated simulation suit 100 includes a processor 160 for real-time analysis of suit data from the components of the simulation suit 100. The processor 160 is designed to store and relay instructions and commands to the components of the simulation suit 100 to simulate various conditions of real life race car driving. The simulation suit 100 includes a safety component 170 in communication with the various components of the simulation suit to disable the various components of the simulation suit 100 during various simulation conditions. The safety component 170 is designed to protect the wearer during various simulation conditions.

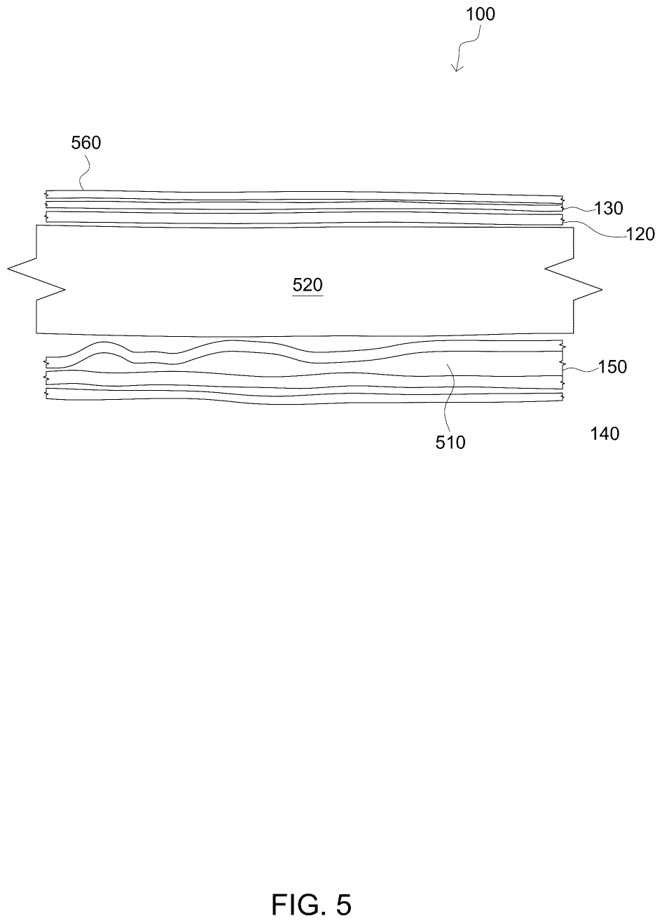

FIG. 5 is a partial cross sectional view of a simulation suit and a wearer, according to one embodiment of the invention. The illustrated simulation suit 100 includes an adjustable pressure component 110, an electro muscular stimulation component 120, a magnetic field generation component 130, and a temperature control component 140.

According to one embodiment of the invention, there is a simulation suit 100 of a simulation system. The illustrated simulation suit 100 includes an adjustable pressure component 110 displaced throughout the simulation suit 100 to stimulate the muscle groups of a wearer during a simulation event. The illustrated adjustable pressure component 110 includes a bladder 510 for a fluid or air to flow therethrough and apply stimulation to a wearer 520. The illustrated simulation suit 100 includes an electro muscular stimulation component 120 to replicate a plurality of muscle strain and fatigue patterns on a wearer 520. The electro muscular stimulation component 120 includes an array of electrodes to deliver electrical impulses with various intensity and pattern to stimulate muscle strain and fatigue patterns to a wearer.

According to one embodiment of the invention, the illustrated simulation suit 100 includes a magnetic field generation component 130 to stimulate magnetic directional forces on a wearer. The magnetic field generation component 130 includes a plurality of electromagnets integrated throughout the simulation suit 100 to generate interactive magnetic fields with adjustable intensity and polarity to a wearer. The illustrated simulation suit 100 includes a temperature control component 140 to stimulate various temperatures on a wearer during various simulation events. The illustrated components of the simulation suit 100 is woven and incorporated within a fabric 500 of the simulation suit 100.

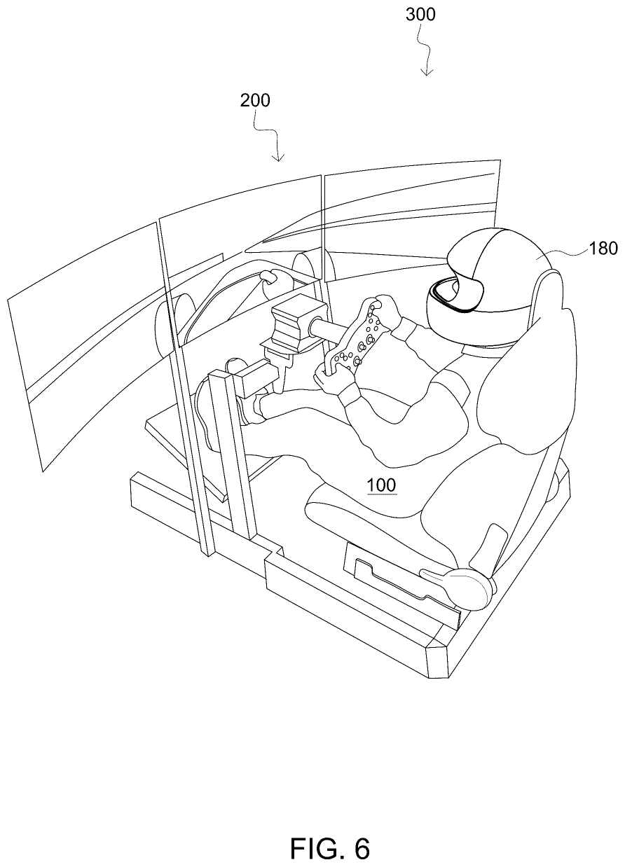

FIG. 6 is a perspective view of a simulation system, according to one embodiment of the invention. There is shown a simulation system 300 including a simulation suit 100 and a simulation apparatus 200.

According to one embodiment of the invention, there is a simulation system 300 including a simulation suit 100 and a simulation apparatus 200. The simulation system 300 is designed to provide a real life simulation event, such as a race car race/event. The illustrated simulation suit 100 includes a training helmet 180; the simulation suit 100 and the training helmet 180 are designed to provide a complete training tool for the presented simulation. The illustrated simulation suit 100 and training helmet 180 apply pressure and stimulation through electric current and magnetic forces to help train a wearer and/or muscle groups of a wearer for real life stresses and strains of driving a race car at a race car event/race. The simulation suit 100 also includes an adjustable pressure component, an electro muscular stimulation component, a magnetic field generation component, a temperature component, a sensor component, a processor, a safety component, and a training helmet to train a wearer on the stresses and strains of real life race car driving/racing.

The illustrated simulation apparatus 200 displays a driver point of view of driving a race car and moves a frame to simulate driving a race car. The simulation apparatus 200 in coordination with the simulation suit 100 and the training helmet 180 to provide a complete and realistic training tool without the dangers of real life race car driving/racing. The simulation apparatus 200 includes an operating component, a movement generating component, a magnetic field generation component, a safety component, a processor, a control component, a suit sensor and a communication component designed to provide a real life simulation with real life conditions, settings, and parameters. The simulation apparatus 200 includes an operating component to simulate and display a simulation event. The simulation apparatus includes a movement generating component to simulate various movements in coordination with the simulation suit and the operating component. The simulation apparatus includes a magnetic field generation component in coordination with the simulation suit to stimulate magnetic directional forces experienced during various operating conditions of a simulation event.

According to one embodiment of the invention, the simulation apparatus 200 includes a processor for real time analysis of apparatus data in relation to the simulation suit. The simulation apparatus 200 includes a control component to coordinate movement of the apparatus in relation to the simulation suit. The simulation apparatus includes a suit sensor to monitor physiological responses of the wearer. The simulation apparatus includes a communication component to coordinate movement and magnetic field generation upon the simulation apparatus; wherein the simulation apparatus includes a safety component to disable the various components of the simulation suit during various conditions.

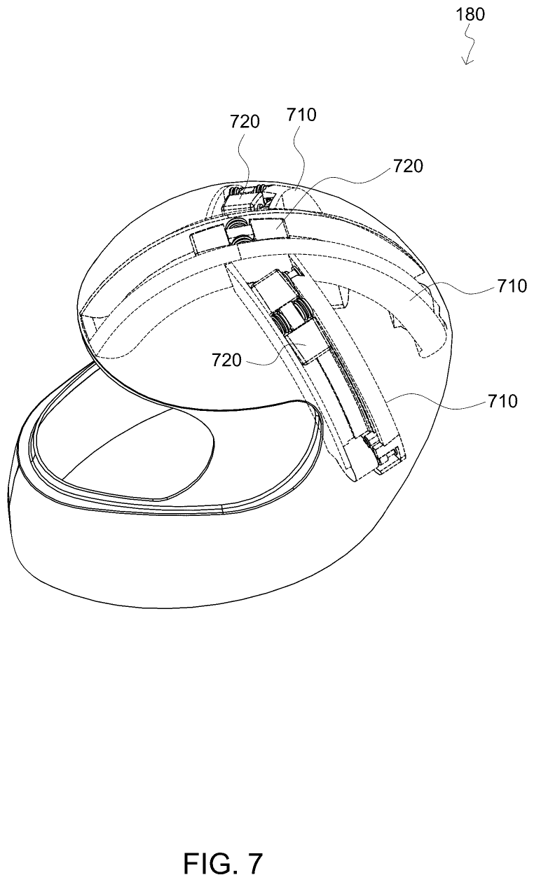

FIG. 7 is a perspective cut away view of a training helmet of a simulation suit, according to one embodiment of the invention. There is shown training helmet 180 of a simulation suit.

According to one embodiment of the invention, there is a training helmet 180 of a simulation suit. The illustrated training helmet 180 is designed to stimulate centrifugal force on a wearer. The illustrated training helmet 180 includes a plurality of weights 720 disposed within the training helmet 180. The weights 720 are disposed on a plurality of tracks 710. The illustrated tracks 720 are disposed along the sides of the training helmet 180 and are disposed diagonally downward towards the rear of the training helmet 180. The illustrated track 720 also includes a track running from the front of the training helmet to the rear of the training helmet. The plurality of weights 720 and the plurality of tracks 710 are disposed throughout the training helmet to stimulate centrifugal force to simulate the pressure and forces experienced when driving a race car in a race car event/race.

According to one embodiment of the invention, the illustrated training helmet 180 includes a plurality of weights 720 disposed on a plurality of tracks 710. The plurality of weights 720 may be adjustable and the weight may be increased or decreased for training. The plurality of tracks 710 may be disposed along muscle groups of a neck and a head area of a wearer to train and strengthen specific muscle groups of a wearer for the rigors and stresses of driving a race car under certain conditions for a prolonged period of time.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

The invention pertains to the technical field of simulation technologies and training equipment, specifically designed to replicate physical sensations associated with G-forces experienced in various environments such as automotive racing, aviation, space travel, diving, and extreme sports.

According to one embodiment of the invention, there is a simulation suit including a sophisticated pressure system capable of using air, water, or oil to create dynamic pressure variations across the wearer's body. This pressure system comprises a network of adjustable bladders or channels, strategically placed to target different body areas. These bladders may be controlled to inflate and deflate, simulating the pressure exerted on the body by high G-forces during acceleration, deceleration, and directional changes. The pressure system is engineered to mimic the intensity and directionality of G-forces, providing a realistic sensation of physical strain.

According to one embodiment of the invention, there is a simulation suit including elastic resistance. Elastic materials are integrated into key areas of the simulation suit to provide resistance-based simulation. These materials are designed to stretch and contract in response to the simulated G-force environment, offering resistance that the wearer must actively work against, much like in real-world high-G scenarios. This feature is especially effective in simulating sustained G-forces, such as those experienced in high-speed cornering or prolonged acceleration.

According to one embodiment of the invention, there is a simulation suit including an electrical muscle stimulation (EMS). EMS technology is employed to induce muscle contractions, simulating the muscle strain typically experienced under G-force conditions. This electrical muscle simulation system targets specific muscle groups with controlled electrical impulses, replicating the physical sensation of muscle exertion and fatigue. The EMS system is governed by a sophisticated control unit that ensures the safety and accuracy of muscle stimulation, allowing for adjustable intensity levels to suit various training requirements and user preferences.

According to one embodiment of the invention, there is a simulation suit including a magnetic field simulation system. The simulation suit utilizes a magnetic field generation and control system to simulate the push-pull dynamics of G-forces. Electromagnets are embedded within the suit and in the external environment or stimulation apparatus (e.g., simulator seat or cockpit), creating interactive magnetic fields. These fields may be modulated to simulate the sensation of being pushed into the seat or pulled forward, aligning with the simulated motion cues.

According to one embodiment of the invention, there is a simulation suit including a control system. At the core of the suit's functionality is an advanced control system. This system integrates inputs from various sensors that monitor the simulation environment (like speed, direction, and user's physiological responses). Based on this data, the control system dynamically adjusts the pressure system, EMS, and magnetic fields, and various components of the simulation suit ensuring a coordinated and immersive simulation experience.

According to one embodiment of the invention, there is a simulation suit including a plurality of safety features for each component of the simulation suit. The simulation suit is designed with multiple safety features, including emergency release mechanisms, automatic pressure regulation, and fail-safes within the EMS and magnetic systems. These features ensure that the user is not subjected to excessive force or stimulation and may quickly disengage from the simulation if necessary.

According to one embodiment of the invention, the simulation system including a simulation suit and a simulation apparatus. The simulation suit may be a training suit for a driver of a race car and the simulation apparatus is a race car simulator. However, the versatility of the simulation suit allows it to be adapted for a wide range of simulation environments or apparatuses. In racing simulators, it may replicate the intense G-forces experienced during high-speed maneuvers. For flight and astronaut training, it offers a realistic representation of the forces encountered during takeoff, in-flight maneuvers, and re-entry. In dive and skydiving simulations, it simulates the pressure and physical strains experienced in these environments. This adaptability makes the suit an invaluable tool for professional training and recreational simulation alike. The simulation apparatus may be designed for water conditions, underwater conditions, land conditions, aerial conditions, and aerospace conditions.

For example, although the training helmet is designed for race car driving training, the training helmet may be adjusted for a plurality of other types of sports, activities or events that require head/neck training and strengthening.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A simulation system, including:
a) a simulation suit, comprising:
a1) a plurality of adjustable pressure components to stimulate pressure on a wearer;
a2) an electro muscular stimulation component to replicate a plurality of muscle strain and fatigue patterns on a wearer;
a3) a magnetic field generation component to stimulate magnetic directional forces on a wearer;
a4) a temperature control component to stimulate various temperatures on a wearer; and
a5) a training helmet to stimulate centrifugal force on a wearer; and
b) a simulation apparatus, comprising:
b1) an operating component to simulate and display a simulation event;
b2) a movement generating component to simulate various movements in coordination with the simulation suit and the operating component; and
b3) a magnetic field generation component in coordination with the simulation suit to stimulate magnetic directional forces experienced during various operating conditions of a simulation event.

2. The system of claim 1, wherein the plurality of adjustable pressure components includes a bladder for a fluid or air to flow therethrough and apply stimulation to a wearer.

3. The system of claim 1, wherein the electro muscular stimulation component includes an array of electrodes to deliver electrical impulses with various intensity and pattern to stimulate muscle strain and fatigue patterns to a wearer.

4. The system of claim 1, wherein the magnetic field generation component includes a plurality of electromagnets integrated throughout the simulation suit to generate interactive magnetic fields with adjustable intensity and polarity to a wearer.

5. The system of claim 1, wherein the simulation suit further comprises:
a6) a processor for real-time analysis of suit data from the components of the suit to adjust the components of the suit to real-time conditions and movement of the simulation apparatus; and
a7) a sensor to monitor physiological responses of the wearer and environmental parameters of the simulation suit.

6. The system of claim 1, wherein the simulation apparatus further comprises:
b4) a processor for real time analysis of apparatus data in relation to the simulation suit;
b5) a control component to coordinate movement of the apparatus in relation to the simulation suit;
b6) a suit sensor to monitor physiological responses of the wearer; and
b7) a communication component to coordinate movement and magnetic field generation upon the simulation apparatus.

7. The system of claim 1, wherein the simulation suit includes a safety component to disable the various components of the simulation suit during various conditions.

8. The system of claim 1, wherein the simulation apparatus includes a safety component to disable the various components of the simulation suit during various conditions.

9. The system of claim 1, further including a haptic feedback system to provide tactile sensations to a wearer corresponding to various conditions.

10. A simulation system, including:
a) a simulation suit, comprising:
a1) a plurality of adjustable pressure components to stimulate pressure on a wearer;
a2) an electro muscular stimulation component to replicate a plurality of muscle strain and fatigue patterns on a wearer;
a3) a magnetic field generation component to stimulate magnetic directional forces on a wearer;
a4) a temperature control component to stimulate various temperatures on a wearer; and
a5) a training helmet to stimulate centrifugal force on a wearer; and
b) a simulation apparatus, comprising:
b1) an operating component to simulate and display a simulation event;
b2) a movement generating component to simulate various movements in coordination with the simulation suit and the operating component; and
b3) a magnetic field generation component in coordination with the simulation suit to stimulate magnetic directional forces experienced during various operating conditions of a simulation event.

11. The system of claim 10, wherein the plurality of adjustable pressure components includes a bladder for a fluid or air to flow therethrough and apply stimulation to a wearer.

12. The system of claim 11, wherein the electro muscular stimulation component includes an array of electrodes to deliver electrical impulses with various intensity and pattern to stimulate muscle strain and fatigue patterns to a wearer.

13. The system of claim 12, wherein the magnetic field generation component includes a plurality of electromagnets integrated throughout the simulation suit to generate interactive magnetic fields with adjustable intensity and polarity to a wearer.

14. The system of claim 13, wherein the simulation suit further comprises:
a6) a processor for real-time analysis of suit data from the components of the suit to adjust the components of the suit to real-time conditions and movement of the simulation apparatus; and
a7) a sensor to monitor physiological responses of the wearer and environmental parameters of the simulation suit.

15. The system of claim 14, wherein the simulation apparatus further comprises:
b4) a processor for real time analysis of apparatus data in relation to the simulation suit;
b5) a control component to coordinate movement of the apparatus in relation to the simulation suit;
b6) a suit sensor to monitor physiological responses of the wearer; and
b7) a communication component to coordinate movement and magnetic field generation upon the simulation apparatus.

16. The system of claim 15, wherein the simulation suit includes a safety component to disable the various components of the simulation suit during various conditions.

17. The system of claim 16, wherein the simulation apparatus includes a safety component to disable the various components of the simulation suit during various conditions.

18. The system of claim 17, further including a haptic feedback system to provide tactile sensations to a wearer corresponding to various conditions.

19. A simulation system, including:
a) a simulation suit, comprising:
a1) a plurality of adjustable pressure components to stimulate pressure on a wearer; wherein the plurality of adjustable pressure components includes a bladder for a fluid or air to flow therethrough and apply stimulation to a wearer;
a2) an electro muscular stimulation component to replicate a plurality of muscle strain and fatigue patterns on a wearer; wherein the electro muscular stimulation component includes an array of electrodes to deliver electrical impulses with various intensity and pattern to stimulate muscle strain and fatigue patterns to a wearer;
a3) a magnetic field generation component to stimulate magnetic directional forces on a wearer; wherein the magnetic field generation component includes a plurality of electromagnets integrated throughout the simulation suit to generate interactive magnetic fields with adjustable intensity and polarity to a wearer;
a4) a temperature control component to stimulate various temperatures on a wearer;
a5) a training helmet to stimulate centrifugal force on a wearer;
a6) a processor for real-time analysis of suit data from the components of the suit to adjust the components of the suit to real-time conditions and movement of the simulation apparatus; and
a7) a sensor to monitor physiological responses of the wearer and environmental parameters of the simulation suit; wherein the simulation suit includes a safety component to disable the various components of the simulation suit during various conditions;
b) a simulation apparatus, comprising:
b1) an operating component to simulate and display a simulation event;
b2) a movement generating component to simulate various movements in coordination with the simulation suit and the operating component;
b3) a magnetic field generation component in coordination with the simulation suit to stimulate magnetic directional forces experienced during various operating conditions of a simulation event. b4) a processor for real time analysis of apparatus data in relation to the simulation suit;
b5) a control component to coordinate movement of the apparatus in relation to the simulation suit;
b6) a suit sensor to monitor physiological responses of the wearer; and
b7) a communication component to coordinate movement and magnetic field generation upon the simulation apparatus; wherein the simulation apparatus includes a safety component to disable the various components of the simulation suit during various conditions; and
c) a haptic feedback system to provide tactile sensations to a wearer corresponding to various conditions.
